(19) United States
(12) Patent Application Publication
(10) Pub. No.: US 2022/0192230 A1
(43) Pub. Date: Jun. 23, 2022

(54) EXPANDED FOODSTUFF- OR ANIMAL FEED EXTRUDATE

(71) Applicant: Daniel SCHAAF, Offenbach (DE)

(72) Inventor: Daniel SCHAAF, Offenbach (DE)

(21) Appl. No.: 17/599,383

(22) PCT Filed: Mar. 10, 2020
(86) PCT No.: PCT/DE2020/100171

§ 371 Date: Sep. 28, 2021

(30) Foreign Application Priority Data
Mar. 28, 2019 (DE) 10 2019 108 011.8

(51) Int. Cl. A23K 40/25; A23K 20/147; A23K 10/30; A23K 20/163

(52) U.S. Cl. CPC A23K 40/25; A23K 20/163; A23K 10/30; A23K 20/147

(57) ABSTRACT

Disclosed is an edible, expandable extrudate having a composition that includes a gel-forming component, a crystalline component having a melting point of up to 150° C., water, and additional components that produce an extrudate composition (dough) having no more than 20 dry wt. % starch and no more than 45 dry wt. % protein and a method for producing an edible expanded extrudate product using water incorporated in the extrudate as the puffing or blowing agent to produce a volumetric expansion of at least 200% as a heated and pressurized extrudate is ejected from an extruder such as a twin-screw extruder.

This application is a national stage of International Application No. PCT/DE2020/100171, filed on Mar. 10, 2020, which claims priority to German Application No. 102019108011.8, filed Mar. 28, 2019, which are incorporated herein by reference in their entireties.

The invention relates to an expanded foodstuff extrudate or animal feed extrudate according to the preamble of claim 1.

The prior art discloses the production of puffed foodstuffs or animal feeds with an extruder.

Screw extrusion has been a standard method of processing foodstuffs since the 1930s. For this purpose, the foodstuff (the extrudate) is supplied to a processing space provided with one or two extrusion screws, in which the motor-driven extrusion screws increase the pressure and, induced by friction and shear, the temperature in the processing space.

Standard extruders for foodstuffs or animal feeds may generate pressures of up to 1000 bar or higher, and heat the foodstuff or animal feed up to 300° C. (For industrial applications there are extruders with even higher values.)

Once the extrudate has passed through the processing space, conveyed by the extrusion screws, it is discharged again through a die.

One of the capabilities of modern extruders is to increase or reduce the temperature during passage and to supply or remove additional substances.

As well as standard practical applications of extrusion such as cooking, mixing, finishing, texturing or sterilizing, extrusion in the foodstuff sector is frequently used for “puffing”, i.e. the expansion of the foodstuff. According to the composition of the extrudate and adjustment of the extrusion parameters, it is possible to achieve expansion or puffing rates of a few percent (the latter case is often referred to as “texturing”) up to several thousand percent (for example in the case of peanut flips consisting of corn starch). Expansion rates of up to 300% are referred to hereinafter as low expansion, and those of more than 300% as high expansion.

In the puffing operation, water-containing extrudates (extrusion doughs) are extruded at temperatures above 100° C. As a result of the pressure built up by the extruder, rather than the water being able to go into a gaseous phase in spite of temperatures exceeding 100° C., it is superheated.

If the extrusion dough is discharged through the die, the phase transition of the water from liquid to gaseous that is not possible within the extruder takes place abruptly.

If an extrudate is suitable, i.e. an extrudate including a structure-forming ingredient in a suitable amount, the expanding steam does not escape into the environment but remains finely divided within the extrudate: the volume of the extrudate increases by up to several thousand percent.

If a suitable structure-forming ingredient is utilized, this expanded form of the foodstuff is preserved even after cooling and condensation of the steam (with a corresponding pressure drop). The extrudate has been puffed.

Foodstuffs processed by puffing play a major role in the snacks sector (in products such as peanut flips) and in breakfast products (for example puffed cereals). Protein-containing extrudates are used as a meat substitute. Extruding and puffing are methods that are also commonly used for finishing foodstuffs.

The puffing of foodstuffs for foodstuff products is attractive for the following reasons: high volume (=low density), generally good absorption capacity for liquids and also for fats, good driability, long shelf life, easy for the consumer to chew, and good “crispy” mouthfeel.

For the understanding of expansion, the physical properties of the ingredients to be extruded are particularly important. The mechanism generally takes place in 3 steps:
1. In order to achieve expansion, an extrudate that undergoes gelatinization as it passes through the processing operation (usually within the extruder, but there are also processes with pregelatinization), so as to give rise to an elastic dough, is necessary.
2. Directly after emergence from the extruder die, bubbles of steam form from superheated water within the dough, which expand the extrusion dough.
3. The phase transition of the water present in the extrusion dough to steam results in evaporative cooling. The dough then has to solidify as it cools for the bubbles formed by the steam to remain stable even after complete cooling and re-liquefaction of the water vapor.

Whether there is expansion in the extrusion and to what degree is also dependent on the suitable adjustment of the extruder (screw speed, material supply, die configuration, addition of water, temperature profile etc.). What are crucial, however, are the physical properties and composition of the extrudate and of the structure-forming ingredients present therein that firstly have to gelatinize and secondly form stable structures after expansion.

This prerequisite is satisfied in a particularly efficient manner by extrudates containing starch (corn, cereal, rice, quinoa or the like and particularly also the starch isolates produced therefrom) as structure-forming ingredient. The underlying chemical details of the gelatinization and structure formation of starch have been well known since the 1840s. The minimum content of starch in an extrudate for expansion still to be possible is 20% dry wt. % (Caroline Joy Steel, Maria Gabriela Vernaza Leoro, Marcio Schmiele, Reinaldo Eduardo Ferreira and Yoon Kil Chang: InTECH, Thermoplastic Extrusion in Food Processing).

Since the 1970s, many patents have been concerned with altering the nutrient composition of puffed extrudates.

Firstly, a very high number of methods of increasing the proportion of plant protein was developed, since these proteins are able to meet the demands on a structure-forming ingredient. A small selection in this regard:
U.S. Ser. No. 000004044159A from Aug. 23, 1977: describes the production of protein-rich flakes with soya.
DD000000155133A1 from May 19, 1982: describes how a puffed extrudate can be produced by prior denaturing from leguminous protein.
U.S. Ser. No. 020050064079A1 from Mar. 24, 2005: describes the production of a dietary fiber-rich puffed extrudate with at least 50% protein and at least 5% starch, with achievement of expansion by virtue of a high expansion speed and high pressures.
US 2013/0040040 A1 from Feb. 14, 2013 and CA000002413951A1 from Nov. 6, 2004: describe the production of puffed foodstuffs based on proteins as structure-forming ingredient, preferably soya protein. For this purpose, for achievement of a good expansion outcome, protein contents in the extrudate of up to 45% to 90% are proposed, preferably deoiled soya flour or soya protein isolate. In the case of lower protein concentrations (<80%), the use of starch-containing foodstuffs (corn, rice, cereal) is additionally proposed in order to achieve the desired expansion.
EP000003395181A1 from Oct. 31, 2018: describes the production of meat-like textures from soya protein, with enablement of an elevated fat content.

Other patents are concerned with further modifications of the extrudate composition using animal proteins, for example with milk powder, slaughter wastes or protein combinations:
CA000002364693A1 from Sep. 28, 2000: describes the production of a puffing extrudate comprising milk powder, up to 12% milk fat, up to 15% sugar and 50% starch or cereal.
DE000003879601T2 from Jul. 1, 1993: describes how 80% animal proteins (slaughter wastes) and 20% vegetable proteins can be used to produce a textured, slightly puffed extrudate by limiting gelatin formation during extrusion.
DE000003039348A1 from Apr. 22, 1982: describes how casein, caseinate, gluten, soya isolate can be used to produce a puffed snack product.

These patents and the specialist literature suggest a lower limit of 45% protein below which noticeable expansion of the extrudate can no longer be observed. High expansion rates are achieved almost exclusively with extrudates having partly or predominantly soya protein or whey protein.

Secondly, many patents are concerned with increasing the dietary fiber content in puffed extrudates, in particular in order to develop products more beneficial to health (positive effects of dietary fibers themselves on health, and reduction in the starch content and hence calorific value):
JP000H03262461A from Nov. 22, 1991: describes how the utilization of chitosan, in spite of up to 30% dietary fiber, can produce a puffed foodstuff. The suggested starch content as structure-forming ingredient is 40%-700.
U.S. Ser. No. 000005151283A from Sep. 29, 1992: proposes utilization of barley extract for improvement of the sensory properties of unexpanded foodstuff having a dietary fiber content of up to 50%.
JP0000H0723739A from Jan. 26, 1995: describes a mixture of proteins, starch and dietary fibers for production of a dietary fiber-rich expanded foodstuff.
U.S. Ser. No. 000005591471A from Jan. 7, 1997: describes the production of an expanded extrudate comprising soya protein, starch and dietary fibers, where the ratio of soya protein to dietary fiber is at least 1:0.4. For achievement of good expansion, the utilization of a foaming agent is suggested.
CA000002068166C from Dec. 30, 2003: extrudes an extrudate with up to 40% dietary fibers without expanding. After specific shaping and drying, there is then expansion merely by heat in a pillow puffing operation.
U.S. Ser. No. 020070054029A1 from Mar. 8, 2007: describes the production of a rice cereal having a dietary fiber content of up to 25%. In order to minimize any adverse effect on further processing steps (including expansion by extrusion) by the dietary fiber, pretreatment of the dietary fibers by several boiling steps is suggested.
WO002006138705A1 from Dec. 28, 2006: describes the production of a dietary fiber-rich foodstuff by coating a puffed, in particular starch-containing, cereal with a dietary fiber-rich layer.
WO 002007124427 A2 from Nov. 1, 2007: describes the production of puffed products having a maximum level of dietary fiber with specific extruder settings and the additional addition of leavening agents. The dietary fiber content may thus be increased above 10%.
WO002009094421A1 from Jul. 30, 2009: describes a method of producing expanded extrudates with expansion-hindering or heat-sensitive ingredients by utilizing 25%-75% pregelatinized starch.
WO002010124922A1 from Nov. 4, 2010: describes the production of a puffed cereal based on 20% rye bran and 50% corn starch.
CN000103238777A from Aug. 14, 2013: describes the production of a rice substitute with a high dietary fiber content, containing 30% to 40% starch-containing rice powder and other starch-containing foodstuffs as a constituent of the extrudate.
U.S. Ser. No. 020170181462A1 from Jul. 29, 2017: is concerned with ways of reducing the expansion-hindering effect of dietary fibers by pelletization thereof, and of thereby producing puffed breakfast cereals having a higher dietary fiber content but less starch. According to the invention, however, a starch content of at least 50% as structure-forming ingredient is proposed here too.

In none of the processes found was a dietary fiber utilized as structure-forming ingredient; instead, in all cases, the problem solved was exclusively that dietary fibers potentially hinder expansion, i.e. reduce the structure-forming properties of starch or proteins or contribute to disadvantageous properties of the puffed extrudate.

Combinations of protein and starch puffed only when the protein content was at least 45 dry wt. %. By way of illustration, no patent reports that a highly puffed result was achievable with a dietary fiber content of more than 40 dry wt. %.

In the case of combinations of starch and dietary fibers, it was in no way possible to achieve a theoretically possible reduction in the starch content to below 25 dry wt. % despite high research expenditure since dietary fibers inhibit the gelatinization of starch. Here too, no examples exist of highly puffed results with a dietary fiber content exceeding 40 dry wt. %.

### Psyllium Husks as Ingredient in Extruded Foodstuffs

Psyllium husks are the seed husks of the plantain species Plantago ovata.

Psyllium husks consist to an extent of 80% water-soluble dietary fibers, and are capable of binding large amounts of water (swelling index>40).

Numerous medical studies have shown Psyllium husks to have positive effects on health.

Psyllium husks in conjunction with water form a slimy gel, which is attributable to the ingredient arabinoxylan, present in Indian Psyllium husks to an extent of up to 30% (Milton H. Fischer, a Nanxiong Yu, b Gary R. Gray, b John Ralph, c Laurens Andersond,* and Judith A. Marlett: The gel-forming polysaccharide of Psyllium husk).

Direct consumption of Psyllium husks in therapeutic amounts (5 g) is difficult on account of their high water binding capacity. There are therefore many approaches to incorporating Psyllium husks into foodstuffs:
U.S. Ser. No. 000005026689A from Jun. 25, 1991: describes the production of cereals with Psyllium husks, stating explicitly that, in the context of that patent, boiling of such doughs with extruders having high pressures should be avoided since expansion is to be avoided. An extruder should be used, if at all, merely for finishing of the dough (mixing, boiling, portioning). The subsequent puffing of the cereals described therein is achieved by means of toasting at 400° C. This publication additionally proposes a starch content of the cereal dough of 20-80%.
U.S. Pat. No. 5,173,296A from Dec. 22, 1992: discloses a marzipan-like mass containing Psyllium seeds that is suitable for offering the medical effects of Psyllium seeds (as laxative, for lowering cholesterol) in a form better tolerated by the consumer. The mass described therein is extruded, but does not expand.
U.S. Ser. No. 000000036067E from Jan. 26, 1999: describes the production of boiled cereals to which ground Psyllium husks are added in combination with water-insoluble dietary fibers owing to their effects on health.
KR102004074163A from Aug. 23, 2004: describes the production of dietary fiber-rich noodles with up to 4% Psyllium husks. The main constituent of the dough is wheat flour. Extrusion is then effected through a noodle extruder.

For extruded foodstuffs too, there are inventions including the use of Psyllium husks:
EP000000144644A2 from Jun. 19, 1985: describes the production of bars or biscuits having a proportion of 10%-80% Psyllium seeds with the aid of an extruder. In addition, there is obligatory use of 10%-30% of a structure-forming ingredient (in the text: stretching agent=“expander”, i.e. rice powder, corn powder, modified starch) in order to achieve the expansion needed for a bar or biscuit. The patent states that the large amounts of Psyllium, with suitable mixing of water, do not prevent the expansion of the stretching agent as expected, but promote it.
GB000002201875A from Sep. 14, 1988: describes the production of a foodstuff containing large amounts of Psyllium husks and other dietary fibers. One of several methods suggested for boiling and finishing this foodstuff is an extruder. Although possible expansion of this mixture is mentioned as possible, it is not described in detail.
U.S. Ser. No. 000005223298A from Jun. 29, 1993: describes the production of an extruded foodstuff with a Psyllium content of up to 10%. The content of this invention is to deactivate the gel-forming properties of the Psyllium seeds by means of an intermediate treatment step in order to achieve a minimum degree of change in the flavor and texture properties of the extrudate that otherwise contains starch in particular.
U.S. Ser. No. 000005382443A from Jan. 17, 1995: describes the production of cereals enriched with Psyllium husks. The Psyllium is treated in a first extrusion step without expansion and then puffed with starch-containing ingredients as structure-forming ingredient in a second extrusion step.
WO 002007124427 A2 from Nov. 1, 2007: describes the production of puffed products having a maximum level of dietary fiber. One possible source of dietary fiber mentioned is Psyllium. The content of the invention is to promote expansion at relatively high dietary fiber concentrations by addition of various blowing agents.
CN000103960593A from Aug. 6, 2014: describes the production of puffed foodstuffs with small amounts of Psyllium husks, and utilizes, as main ingredient and structure-forming ingredient, starch-containing wheat bran, assisted by baking powder.

Most patents are concerned with suppressing the rubbery consistency that results from the Psyllium husks in the extrudate:
EP000000144644A2 describes positive properties of Psyllium husks that are already possible for expansion, but uses starch as structure-forming ingredient for gelatinization, but this can achieve only minor expansions, such that products that can be created are merely bars or biscuits, not highly expanded products.

### Sugar Alcohols (Polyols) in Extruded Foodstuffs

Sugar alcohols (polyols) are used as sugar substitutes in foodstuff production. Examples of such sugar alcohols are sorbitol, maltitol, isomalt, erythritol, xylitol, lactitol and mannitol. All sugar alcohols form sugar-like crystals, and have somewhat reduced sweetening power compared to sugar. Sorbitol, erythritol, xylitol, lactitol have a melting point below 120° C., i.e. a lower value compared to the melting point of sugar.

For sugar alcohols too, there are inventions associated with puffed foodstuffs. However, these are not used in a functional manner for the extrusion process, but rather merely for reduction in the sugar and in the calorific value, in:
EP000001858349B1 from May 26, 2010: describes the use of isomalt in extruded cereal products.
CN000105614682A from Oct. 22, 2015: uses the sugar alcohol erythritol in puffed cereals in order to reduce the glycemic index. The sugar alcohol replaces sugar as sweetener, but has no functional effects.

### DESCRIPTION OF THE INVENTION

Whereas, in existing processes, the creation of a puffed foodstuff is possible either with a starch content of at least 20 dry wt. % or a content of protein of at least 45 dry wt. %, since only these ingredients are suitable according to the prior art as structure-forming ingredients, the invention proposed discloses a foodstuff extrudate or animal feed extrudate with a starch content between 0-20 dry wt. % (i.e. either starch-free or having only a low starch content) and a protein content of 0-45 dry wt. % (i.e. either protein-free or having a likewise only low protein content or one lower than that disclosed in the prior art to date). This eliminates the significance of starch contents and/or protein contents in the foodstuff extrudate or animal feed extrudate of the invention as essential structure-forming ingredients.

Claim 1 therefore claims a foodstuff extrudate or animal feed extrudate which is characterized in that the foodstuff extrudate or animal feed extrudate, as structure-forming ingredient, comprises a gel-forming dietary fiber and a crystalline ingredient having a melting point of not more than 150° C., and the other ingredients are present as fillers, the extrudate of the invention includes, in the sum total of all proportions by weight, a starch content of 0.1%-20% and/or a protein content of 0.1%-45%, the proportion of the crystalline ingredient in the foodstuff extrudate or animal feed extrudate is 15%-70 dry wt. % of the sum total of all proportions by weight and the expansion of the foodstuff extrudate or animal feed extrudate is more than 300%.

In the case of a proportion of the crystalline ingredient that melts at up to 150° C. in the extrusion dough of more than 70 dry wt. %, the dough becomes so fluid after this ingredient has melted in the extruder that there is no longer any occurrence of expansion.

According to claim 2, the gel-forming ingredient is Psyllium husks and/or another natural or synthetic substance consisting at least to an extent of 10 dry wt. % of the polysaccharide arabinoxylan.

The invention is based on the finding that Psyllium husks, given suitable configuration of the extruder, are capable of gelatinization, i.e. of forming a gel-like structure that elasticizes the extrusion dough. Such extrusion doughs may then expand by 300% or more.

“Gelatinization” here is an operation that alters the elasticity of an extrusion dough (=extrudate of high viscosity after addition of water) by mechanical and/or thermal treatment to give a gel-like structure. While the relevant literature uses the term “gelatinization” predominantly for starch-based processes, the term is also applied here mutatis mutandis to comparable protein- and dietary fiber-based reactions.

However, the disadvantage of Psyllium is that, in a water-containing dough, the result of the extrusion becomes rubbery and, by contrast with starch and proteins, Psyllium seeds are incapable of sufficiently stabilizing the structures formed by the expansion.

There is therefore the risk that, once the water vapor condenses after cooling, the expanded foodstuff extrudate or animal feed extrudate will collapse again.

Therefore, according to the invention, as per claim 3, a crystalline ingredient that melts at up to 150° C. is added to the foodstuff extrudate or animal feed extrudate in a proportion of 15%-70 dry wt. % of the sum total of all proportions by weight, and the crystalline ingredient that melts at up to 150° C. is advantageously a polyol, polysaccharide or a type of sugar with a correspondingly low melting point or a mixture created therefrom.

Claim 4 defines the polyol as a sugar alcohol.

In a particular embodiment of the invention, according to claim 5, the crystalline ingredient that melts at up to 150° C. is erythritol and/or xylitol.

The crystalline ingredient that melts at up to 150° C. is heated in the extruder to a temperature above the melting point, is liquefied and is then distributed very homogeneously in the extrusion dough by the extruder action. After expansion through the die, and induced by the evaporative cooling of the water, the crystalline ingredient that melts at up to 150° C. crystallizes and hence stabilizes the expanded dough.

According to claim 6, the proportion of the gel-forming dietary fiber in the foodstuff extrudate or animal feed extrudate is 8%-40 dry wt. % of the sum total of all proportions by weight, since expansion will not take place otherwise. In the case of a proportion of Psyllium husks, for example, exceeding 40 dry wt. %, the extrusion dough becomes so labile that the extrudate collapses again immediately after exiting from the die.

After drying of the foodstuff extrudate or animal feed extrudate, the Psyllium husks also lose their rubbery consistency, and the foodstuff extrudate or animal feed extrudate produced takes on a crispy consistency.

What is essential for the foodstuff extrudate or animal feed extrudate of the invention in this respect, aside from the gel-forming ingredient as one constituent, is at least one crystalline ingredient having a melting point of not more than 150° C., preferably a sugar alcohol, especially erythritol and/or xylitol, the crystals of which are melted in the extruder and, on recrystallization, stabilize the expansion of the foodstuff extrudate or animal feed extrudate.

With the aid of the expanded, extruded, puffed foodstuff or animal feed of the invention, based on Psyllium seeds and with erythritol, for example, as structure-forming ingredient combination, it is possible to produce almost sugar-, fat- and starch-free, highly puffed foodstuff extrudates or animal feed extrudates of very low calorific value.

Since it is possible through the invention in principle to produce carbohydrate-free foodstuffs, it is possible to produce highly puffed snack and breakfast products for increasingly popular low-carb nutrition.

Furthermore, the invention enables highly puffed foodstuff extrudate or animal feed extrudate having a dietary fiber content of up to 70 dry wt. %, where not all dietary fiber constituents also act as structure-forming ingredients.

In summary, it can be stated that, in the puffing of foodstuffs or animal feeds, starch at concentrations exceeding 25 dry wt. % in the foodstuff extrudate or animal feed extrudate is the structure-forming ingredient usually used for expansion. Starch in high concentrations (>50 dry wt. %) enables very high expansions. The present invention, however, by contrast with the prior art, concerns foodstuff extrudate or animal feed extrudates without starch contents or extrudates having starch contents of less than 20 dry wt. %, such that these starch contents have only a minor effect, if any, on expansion.

Proteins are of different suitability as a structure-forming ingredient according to the type and concentration of the protein in the foodstuff extrudate or animal feed extrudate (typically >45 dry wt. %). Vegetable proteins may lead to expansion in high concentrations; animal proteins may likewise contribute to expansion in particular methods. The present invention, however, by contrast with the prior art, concerns foodstuff extrudates or animal feed extrudates without protein contents or extrudate with protein contents of less than 45 dry wt. %, such that these protein contents have only a minor effect, if any, on expansion.

Further foodstuff extrudate or animal feed extrudates of the invention, according to claim 7, include powdered dietary fiber, cereal bran, fiber products of relevance to the foodstuffs or animal feeds sector (e.g. potato fibers, apple fibers, wheat fibers, pea fibers, cacao fibers from the shells of the cacao bean, or else licorice), cereal products, seed products, nut products, dried fruit, dried vegetables, herbs, spices, yeasts, fungi, minerals, sweeteners including artificial sweeteners, swelling agents of relevance to the foodstuffs or animal feeds sector, mucilages of relevance to the foodstuffs or animal feeds sector, bones, emulsifiers, gelatins, leavening agents, dyes, flavorings, inulin, resistant starch, modified starch, dextrose, polysaccharides, oligosaccharides, pectins, synthetic foodstuff ingredients, ground proteins, protein concentrates, protein isolates (all protein sources each of animal or vegetable origin), either alone or in combination, as further ingredients of no relevance to expansion, although maintaining the fulfillment of the condition from claim 1 that, in the sum total of all proportions by weight, the total starch content of the foodstuff extrudate or animal feed extrudate is between 0.1%-20 dry wt. % and/or the total protein content is between 0.1%-45 dry wt. %.

As a specific embodiment of the invention, claim 8 claims that the extrusion dough consists of a mixture of 10% Psyllium husks, 30% erythritol, 30% fiber products and 30% ground protein, and a proportion by weight of 10% of water.

Described hereinafter is an advantageous combination of ingredients in the foodstuff extrudate or animal feed extrudate of the invention, as is the production of extrusion dough by a known production method:

### Example

A mixture of 10 dry wt. % Psyllium seeds, 30 dry wt. % erythritol, 30 dry wt. % cacao fibers and 30 dry wt. % deoiled pumpkinseed flour was extruded in a twin-screw extruder. 10% percent by weight of water was added within the extruder, and a temperature of 140° C. was established. The pressure was 60-80 bar. The passage time through the extruder was about 30 seconds.

Discharge was effected through a 2.5 mm die. The foodstuff extrudate or animal feed extrudate expanded to 6 mm, which constituted a radial expansion by almost 600%. Directly after the expansion, the foodstuff extrudate or animal feed extrudate had a soft but stable structure. After drying to a water content below 5%, a crispy consistency was established.

1. An expanded foodstuff extrudate or animal feed extrudate,
wherein
the foodstuff extrudate or animal feed extrudate, as structure-forming ingredient, comprises a gel-forming dietary fiber and a crystalline ingredient having a melting point of not more than 150° C.,
and the other ingredients are present as fillers,
the foodstuff extrudate or animal feed extrudate includes, in the sum total of all proportions by weight, a starch content of 0.1%-20 dry wt. % and/or a protein content of 0.1%-45 dry wt. %,
the proportion of the crystalline ingredient in the foodstuff extrudate or animal feed extrudate is 15%-70% of the sum total of all proportions by weight
and the expansion of the foodstuff extrudate or animal feed extrudate is more than 300%.

2. The expanded foodstuff extrudate or animal feed extrudate as claimed in claim 1,
wherein
the gel-forming ingredient is Psyllium husks and/or a natural or synthetic substance consisting at least to an extent of 10 dry wt. % of the polysaccharide arabinoxylan.

3. The expanded foodstuff extrudate or animal feed extrudate as claimed in claim 1,
wherein
the crystalline ingredient that melts up to 150° C. is a polyol, polysaccharide or a type of sugar having a correspondingly low melting point or a mixture produced therefrom.

4. The expanded foodstuff extrudate or animal feed extrudate as claimed in claim 3,
wherein
the polyol is a sugar alcohol.

5. The expanded foodstuff extrudate or animal feed extrudate as claimed in claim 4,
wherein
the sugar alcohol is erythritol and/or xylitol.

6. The expanded foodstuff extrudate or animal feed extrudate as claimed in claim 1,
wherein
the proportion of gel-forming dietary fiber in the foodstuff extrudate or animal feed extrudate is 8%-40 dry wt. % of the sum total of all proportions by weight.

7. The expanded foodstuff extrudate or animal feed extrudate as claimed in claim 1,
characterized in that wherein
powdered dietary fiber, cereal bran, fiber products of relevance to the foodstuffs or animal feeds sector, cereal products, seed products, nut products, dried fruit, dried vegetables, herbs, spices, yeasts, fungi, minerals, sweeteners including artificial sweeteners, swelling agents of relevance to the foodstuffs or animal feeds sector, mucilages of relevance to the foodstuffs or animal feeds sector, emulsifiers, gelatins, leavening agents, dyes, flavorings, inulin, resistant starch, modified starch, dextrose, polysaccharides, oligosaccharides, pectins, synthetic foodstuff ingredients, ground proteins, protein concentrates, protein isolates, either alone or in combination, are present as further fillers.

8. The expanded foodstuff extrudate or animal feed extrudate as claimed in claim 1,
wherein
the foodstuff extrudate or animal feed extrudate includes, as constituents, 10 dry wt. % Psyllium husks, 30 dry wt. % erythritol, 30 dry wt. % fiber products and 30 dry wt. % deoiled ground protein of the sum total of all proportions by weight.
